(19) United States
(12) Patent Application Publication
(10) Pub. No.: US 2026/0186014 A1
(43) Pub. Date: Jul. 2, 2026

(54) FULLY AUTOMATIC MEDICINE TESTING INSTRUMENT AND AUTOMATIC TESTING METHOD

(71) Applicants: Shandong Institute for Food and Drug Control, Shandong (CN); Shandong Yeedo Biotechnology Co., Ltd., Shandong (CN); Hanon Advanced Technology Group Co., Ltd., Jinan (CN)

(72) Inventors: Liping Gong, Shandong (CN); Ruiqing Xian, Shandong (CN); Feng Shi, Shandong (CN); Pengfei You, Shandong (CN); Baojian Hang, Shandong (CN); Haiyan Liang, Shandong (CN); Zhenfang Zhang, Jinan (CN)

(73) Assignees: Shandong Institute for Food and Drug Control, Shandong (CN); Shandong Yeedo Biotechnology Co., Ltd., Shandong (CN); Hanon Advanced Technology Group Co., Ltd., Jinan (CN)

(21) Appl. No.: 19/360,922

(22) Filed: Oct. 16, 2025

(30) Foreign Application Priority Data
Dec. 27, 2024 (CN) 202411946974.9

(51) Int. Cl. G01N 35/10; G01N 35/00; G01N 35/04

(52) U.S. Cl. CPC G01N 35/1011; G01N 35/1002; G01N 2035/00346; G01N 2035/00524; G01N 2035/0491; G01N 2035/1025

(57) ABSTRACT

A fully automatic medicine testing instrument and an automatic testing method are provided. The fully automatic medicine testing instrument includes an outer housing. A shaking mechanism, a heating mechanism, a reagent reservoir configured to store test samples and test reagents, an optical detection mechanism configured to test absorbance of test samples, a moving mechanism configured to move microplate and pipettes, a pipette holder, and a microplate holder configured to hold microplate for treating test samples are arranged inside the outer housing. The reagent reservoir is located in middle of bottom of the outer housing, the pipette holder and the microplate holder are respectively located on two sides of the reagent reservoir, the optical detection mechanism and the shaking mechanism are respectively located on the other two sides of the reagent reservoir, and the heating mechanism is located on one side, close to the microplate holder, of the shaking mechanism.

### CROSS-REFERENCE TO RELATED APPLICATION

This application claims the priority benefit of China application serial no. 202411946974.9, filed on Dec. 27, 2024. The entirety of the above-mentioned patent application is hereby incorporated by reference herein and made a part of this specification.

### TECHNICAL FIELD

The present disclosure relates to the field of medicine testing devices, and particularly, to a fully automatic medicine testing instrument and an automatic testing method.

### BACKGROUND

Testing of medicines, such as biological products, enables the evaluation of biological products such as heparin. Through the testing, parameters like heparin potency can be determined, and subsequently the activity and other indicators are obtained. This is of significant importance for the application of biological products.

Currently, the potency testing of biological products such as heparin involves complex procedures that pose significant challenges for automation. While existing testing devices utilize robotic arms for operation under instructions, they still require substantial manual intervention and cannot achieve complete automation throughout the whole testing process. This limitation ultimately results in low testing efficiency.

### SUMMARY

To solve the problem of low efficiency in testing medicines such as biological products, the present disclosure provides a fully automatic medicine testing instrument.

A fully automatic medicine testing instrument provided by the present disclosure adopts the following technical solution.

The fully automatic medicine testing instrument includes an outer housing. A shaking mechanism, a heating mechanism, a reagent reservoir, an optical detection mechanism, a moving mechanism, a pipette holder, and a microplate holder are arranged inside the outer housing. The reagent reservoir is configured to store test samples and test reagents, the pipette holder is configured to hold pipettes for transferring reagents, the pipettes are configured to draw the test samples and test reagents, the microplate holder is configured to hold a microplate for treating the test samples, the moving mechanism is configured to move the microplate and the pipettes, the shaking mechanism is configured to shake the microplate, the heating mechanism is configured to heat a reagent in the microplate, the optical detection mechanism is configured to test absorbance of the test samples, the moving mechanism is connected to an inner top of the outer housing, the reagent reservoir is located in the middle of a bottom of the outer housing, the pipette holder and the microplate holder are respectively located on two sides of the reagent reservoir, the optical detection mechanism and the shaking mechanism are respectively located on the other two sides of the reagent reservoir, and the heating mechanism is located on one side, close to the microplate holder, of the shaking mechanism.

By adopting the above technical solution, the shaking mechanism, the heating mechanism, and the optical detection mechanism are integrated inside the outer housing, such that the whole process from biological product sample processing to result testing can be completed in one device. Through the design of the moving mechanism, the instrument can automatically move the microplate and the pipettes, thereby reducing steps and time of manual operation are reduced, and enhancing testing efficiency; automatic operation also helps reduce human errors and enhance accuracy of test results; and besides, all components inside the instrument are distributed reasonably according to a testing sequence, such that a moving path of the moving mechanism is more concise, and the problem of repeated movement of the moving mechanism is solved.

Optionally, a collection box is arranged between the pipette holder and the shaking mechanism, and is configured to collect used pipettes.

By adopting the above technical solution, the collection box for collecting the pipettes is arranged between the pipette holder and the shaking mechanism, and after the test reagents or test samples are added into the microplate on the shaking mechanism through the pipettes, the used pipettes are driven by the moving mechanism to move to a position above the collection box, the moving mechanism is separated from the pipettes, and the pipettes drop into the collection box; and after separation from the pipettes, the moving mechanism moves to a position above the pipette holder and is equipped with unused pipettes, thereby further optimizing the moving path of the moving mechanism and enhancing the testing efficiency.

Optionally, the moving mechanism includes a mounting base, a pipetting assembly, a clamping assembly, a driving assembly, a first lifting component, and a second lifting component. The driving assembly is connected with the outer housing, the mounting base is connected with the driving assembly, the driving assembly drives the mounting base to move in a plane parallel to a bottom surface of the outer housing, the pipetting assembly is connected with the mounting base through the first lifting component, the first lifting component drives the pipetting assembly to move in a direction perpendicular to the bottom surface of the outer housing, the pipetting assembly is detachably connected with the pipettes, the clamping assembly is connected with the mounting base through the second lifting component, the second lifting component drives the clamping assembly to move in a direction perpendicular to the bottom surface of the outer housing, and the clamping assembly is configured to clamp the microplate.

Optionally, the pipetting assembly includes the pipettes and a pipetting gun. The pipetting gun includes a plurality of connecting nozzles configured to be connected with the pipettes, the connecting nozzles are hollow pipe structures, two sealing rings are arranged on an outer wall of each connecting nozzle, the two sealing rings are arranged in an axial direction of each connecting nozzle, and the connecting nozzles are in interference fit with openings of the pipettes.

By adopting the above technical solution, the two sealing rings are arranged on the outer wall of each connecting nozzle, such that a sealing effect at connection portions of the connecting nozzles and the pipettes is enhanced, and connection between the connecting nozzles and the pipettes is more stable. Therefore, a liquid is transferred more stably in the pipetting process, and errors due to liquid leakage or connection loosening are reduced.

Optionally, a separating plate is arranged on the pipetting gun and provided with a plurality of through holes, the plurality of through holes are in one-to-one correspondence with the plurality of connecting nozzles, the connecting nozzles are inserted into corresponding through holes, the separating plate is connected with the pipetting gun through an electric push cylinder, and the electric push cylinder drives the separating plate to slide in the axial direction of each connecting nozzle.

By adopting the above technical solution, the separating plate is arranged on the pipetting gun, the separating plate is connected to the pipetting gun through the electric push cylinder, and the connecting nozzles of the pipetting gun pass through the through holes formed in the separating plate and are connected with the pipettes. When the pipettes are used and required to be separated from the pipetting gun, the electric push cylinder drives the separating plate to move close to the pipettes, and the separating plate is abutted against end parts of the pipettes. The electric push cylinder continues to push the separating plate to move, and the pipettes are separated from the connecting nozzles of the pipetting gun under a pushing force of the separating plate, thereby enhancing convenience in simultaneously separating a plurality of pipettes from the connecting nozzles of the pipetting gun and enhancing the testing efficiency.

Optionally, the clamping assembly includes a driving element and two clamping jaws. The driving element is connected with the second lifting component, and drives the two clamping jaws to approach or separate from each other, two tapered lugs are arranged on each of the sides, close to each other, of the two clamping jaws, and the two tapered lugs are arranged symmetrically.

By adopting the above technical solution, the driving element drives the two clamping jaws to approach or separate from each other, the two clamping jaws are utilized to clamp the microplate, and the two tapered lugs are symmetrically arranged on each of the sides, close to each other, of the two clamping jaws. When the microplate is clamped, four tapered lugs are abutted against side walls of the microplate, and the design of the tapered lugs increases a frictional force when the clamping jaws are in contact with the microplate, such that the microplate is clamped more steadily. Additionally, symmetrical arrangement of the tapered lugs ensures uniform distribution of a clamping force, and avoids damage of an object or unsteady clamping due to a nonuniform clamping force.

Optionally, an anti-volatilization reagent kit is arranged inside the outer housing, is configured to accommodate volatile test reagents, and includes a kit body and a kit cover, the kit body is configured to accommodate the volatile test reagents, the kit cover is hinged with the kit body, the kit cover is configured to seal an opening of the kit body, side walls of the kit cover are provided with grooves, a length direction of each groove is perpendicular to a rotary axis of the kit cover, and pulling blocks configured to be inserted into the grooves are arranged on side walls, far from the tapered lugs, of the clamping jaws.

By adopting the above technical solution, the anti-volatilization reagent kit is arranged inside the outer housing, and the anti-volatilization reagent kit is configured to accommodate the volatile test reagents, to effectively seal the reagents and prevent the reagents from dispersing into the air, thereby ensuring purity and stability of the reagents and enhancing testing accuracy. Moreover, the side walls of the kit cover are provided with the grooves, the pulling blocks matched with the grooves are arranged on the clamping jaws, and when the kit cover is required to be opened, the clamping jaws may be inserted into the grooves through the pulling blocks, and the driving assembly drives the clamping jaws to move, so as to drive the kit cover to rotate and open, thereby improving an automation level of the testing instrument and allowing the testing process to be more smooth and efficient.

Optionally, the pipette holder includes a holder body and a pipette holding plate, a plurality of holding holes for holding the pipettes are formed in the pipette holding plate, the pipette holding plate is detachably connected with the holder body, the anti-volatilization reagent kit is located on one side of the pipette holder, and the pipette holder limits an opening angle of the kit cover to less than 180 degrees.

By adopting the above technical solution, the pipette holding plate is detachably connected with the holder body, such that experimental personnel can adjust or replace the holding plate according to an actual requirement to adapt to different specifications or quantities of pipettes, thereby enhancing flexibility and practicability of the instrument. Moreover, the anti-volatilization reagent kit is located on one side of the pipette holder, the pipette holder is configured to limit the opening angle of the kit cover to less than 180 degrees, and when the test reagents in the anti-volatilization reagent kit are completely used, the pulling blocks on the clamping jaws are utilized to push the kit cover to rotate from one side, deviated from the kit body, of the kit cover, such that the kit cover is fastened to the kit body.

Optionally, the shaking mechanism includes a supporting tray configured to clamp the microplate, and any three inner walls of the supporting tray are fixedly connected with spring discs.

By adopting the above technical solution, the supporting tray is configured to clamp the microplate, and the microplate may be securely fixed to the shaking mechanism, thereby avoiding experimental errors due to looseness in the shaking process; the spring discs have excellent elasticity and restoring ability, and can generate stable vibration waves in the shaking process, such that liquids or samples in the microplate can be uniformly mixed; and moreover, any three inner walls of the supporting tray are fixedly connected with the spring discs, such that the microplate is located more precisely, and the stability of clamping the microplate by the clamping assembly is enhanced.

The present disclosure also provides an automatic testing method for a fully automatic medicine testing instrument, which adopts the following technical solution:
the automatic testing method is applied to the above fully automatic medicine testing instrument, and includes:
configuring target positional information for a pipettor, to ensure that the pipettor automatically moves according to the target positional information;
obtaining real-time positional information of the pipettor;
sending, when the pipettor is located at an operating point position, a liquid level detection instruction to a liquid level detection sensor and obtaining current liquid level information; and
calculating a vertical movement distance based on the current liquid level information when the current liquid level information is inconsistent with preset empty liquid level information, including: obtaining a first parameter of a corresponding container by looking up a table based on a current operating point position; during liquid aspiration, based on a current liquid aspiration volume, correcting the current liquid level information when the current liquid aspiration volume is greater than a first threshold; and calculating the vertical movement distance based on the first parameter and the corrected liquid level information, and sending the movement distance to the pipettor, to control an immersion depth of the pipettor below a liquid level.

In conclusion, the present disclosure has at least one of the following beneficial technical effects:
1. the shaking mechanism, the heating mechanism, and the optical detection mechanism are integrated inside the outer housing, such that the whole process from biological product sample processing to result testing can be completed in one device. Through the design of the moving mechanism, the instrument can automatically move the microplate and the pipettes, thereby reducing the steps and time of manual operation, and enhancing the testing efficiency; automatic operation also helps reduce the human errors and enhance the accuracy of the test results; and besides, all components inside the instrument are distributed reasonably according to the testing sequence, the moving path of the moving mechanism is more concise, and the problem of repeated movement of the moving mechanism is solved;
2. the two tapered lugs are symmetrically arranged on each of the sides, close to each other, of the two clamping jaws, and when the microplate is clamped, the four tapered lugs are abutted against the side walls of the microplate, and the design of the tapered lugs increases the frictional force when the clamping jaws are in contact with the microplate, such that the microplate is clamped more steadily; and additionally, the symmetrical arrangement of the tapered lugs ensures uniform distribution of the clamping force, and avoids damage of an object or unsteady clamping due to the nonuniform clamping force; and
3. the anti-volatilization reagent kit is arranged inside the outer housing, and the anti-volatilization reagent kit is configured to accommodate the volatile test reagents, to effectively seal the reagents and prevent the reagents from dispersing into the air, thereby ensuring the purity and stability of the reagents and enhancing the testing accuracy. Moreover, the side walls of the kit cover are provided with the grooves, the pulling blocks matched with the grooves are arranged on the clamping jaws, and when the kit cover is required to be opened, the clamping jaws may be inserted into the grooves through the pulling blocks, and the driving assembly drives the clamping jaws to move, so as to drive the kit cover to rotate and open, thereby improving the automation level of the testing instrument and allowing the testing process to be more smooth and efficient.

### BRIEF DESCRIPTION OF DRAWINGS

The drawings described herein provide further understandings of the present disclosure, and constitute one part of the present disclosure. The schematic embodiments and their description in the present disclosure are used for interpreting the present disclosure, not for improperly limiting the present disclosure. In the drawings:

FIG. 1 is a schematic diagram of an overall structure according to an embodiment of the present disclosure;

FIG. 2 is a schematic diagram of an internal structure of an outer housing according to an embodiment of the present disclosure;

FIG. 3 is a schematic structural diagram of a pipetting assembly according to an embodiment of the present disclosure;

FIG. 4 is a schematic structural diagram of a pipette according to an embodiment of the present disclosure;

FIG. 5 is a schematic structural diagram of a clamping assembly according to an embodiment of the present disclosure;

FIG. 6 is a schematic structural diagram of clamping jaws according to an embodiment of the present disclosure;

FIG. 7 is a schematic structural diagram of an anti-volatilization reagent kit according to an embodiment of the present disclosure;

FIG. 8 is a schematic structural diagram of a pipette holder according to an embodiment of the present disclosure;

FIG. 9 is a schematic structural diagram of a shaking mechanism according to an embodiment of the present disclosure; and

FIG. 10 is a flowchart of an automatic testing method for a fully automatic medicine testing instrument according to an embodiment of the present disclosure.

In the figures: 100: shaking mechanism; 110: supporting tray; 120: spring disc; 200: heating mechanism; 300: reagent reservoir; 400: optical detection mechanism; 500: moving mechanism; 510: mounting base; 520: pipetting assembly; 521: pipette; 522: pipetting gun; 523: connecting nozzle; 524: sealing ring; 525: separating plate; 530: clamping assembly; 531: clamping jaw; 532: tapered lug; 533: pulling block; 600: pipette holder; 610: holder body; 620: pipette holding plate; 621: holding hole; 700: microplate holder; 800: collection box; 900: anti-volatilization reagent kit; 910: kit body; 920: kit cover; and 921: groove.

### DESCRIPTION OF EMBODIMENTS

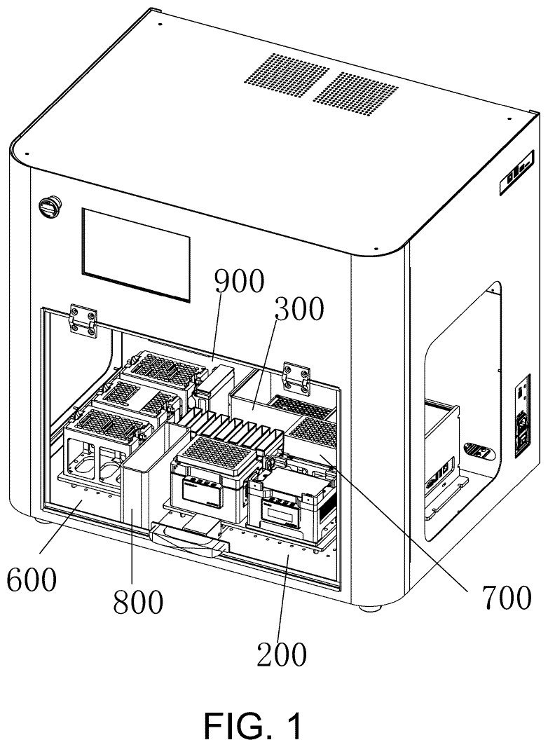

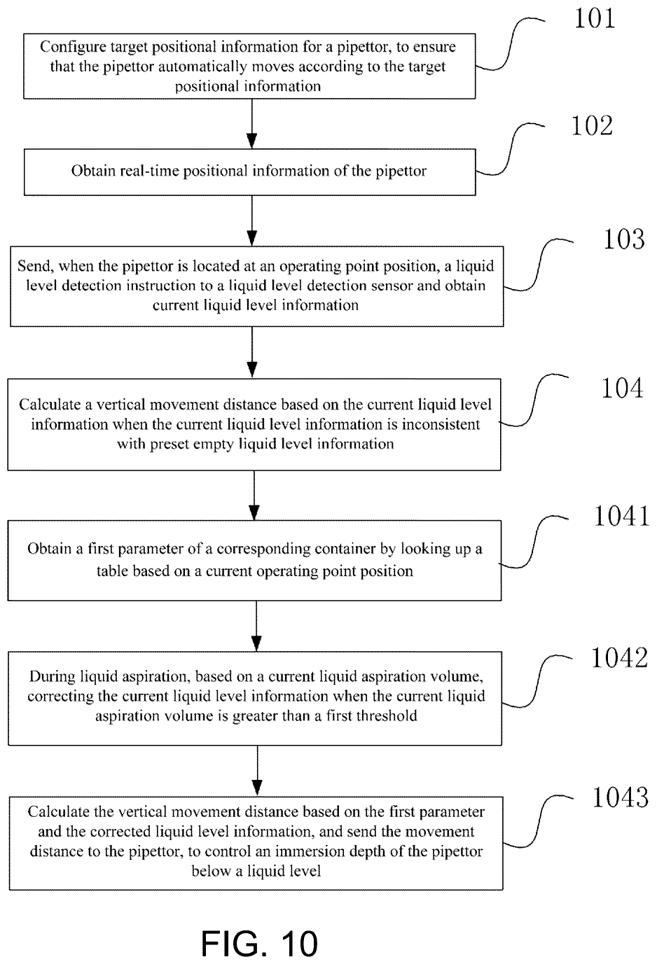

To explain an overall concept of the present disclosure more clearly, the present disclosure is further described in detail below with reference to FIG. 1 to FIG. 10.

Specific details are explained in the description below, to fully understand the present disclosure. However, the present disclosure also can be implemented in other manners different from those described herein. Therefore, the protection scope of the present disclosure is not limited by the specific embodiments disclosed below. It should be noted that without conflicts, the embodiments and characteristics therein of the present disclosure may be combined.

In the present disclosure, unless otherwise expressly specified and limited, the terms “mounted”, “interconnected”, “connect”, and “secured” are to be interpreted broadly, and may be, for example, fixedly connected, detachably connected, or integrally connected, may be mechanically, electrically connected, or communicated, may be directly connected, or indirectly connected through an intermediate medium, and may also be communicated internally between two elements or interacted between the two elements. Those of ordinary skill in the art may understand specific meanings of the above terms in the present disclosure according to specific situations.

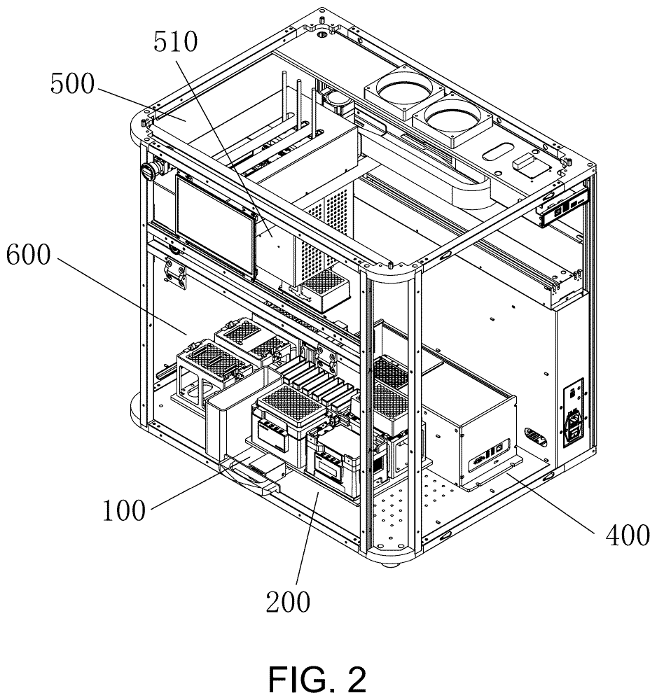

An embodiment of the present disclosure discloses a fully automatic medicine testing instrument. Referring to FIG. 1 and FIG. 2, the fully automatic medicine testing instrument includes an outer housing, the outer housing is a hollow rectangular structure, and glass windows are arranged on four side walls of the outer housing. A shaking mechanism 100, a heating mechanism 200, a reagent reservoir 300, an optical detection mechanism 400, a moving mechanism 500, a pipette holder 600, a microplate holder 700, and an anti-volatilization reagent kit 900 are arranged inside the outer housing. The reagent reservoir 300 is configured to store test samples and test reagents, the pipette holder 600 is configured to hold pipettes 521 for transferring reagents, the pipettes 521 are configured to draw the test samples and test reagents, the microplate holder 700 is configured to hold a microplate for treating the test samples, the moving mechanism 500 is configured to move the microplate and the pipettes 521, the shaking mechanism 100 is configured to shake the microplate, the heating mechanism 200 is configured to heat reagents in the microplate, the optical detection mechanism 400 is configured to test absorbance of the test samples, and the anti-volatilization reagent kit 900 is configured to store volatile test reagents.

The moving mechanism 500 is mounted on an inner top of the outer housing, the reagent reservoir 300 is located in the middle of a bottom of the outer housing, the pipette holder 600 and the microplate holder 700 are respectively located on two sides of the reagent reservoir 300, the optical detection mechanism 400 and the shaking mechanism 100 are respectively located on the other two sides of the reagent reservoir 300, the heating mechanism 200 is located on one side, close to the microplate holder 700, of the shaking mechanism 100, and the anti-volatilization reagent kit 900 is located on one side, close to the optical detection mechanism 400, of the pipette holder 600.

The shaking mechanism 100, the heating mechanism 200, and the optical detection mechanism 400 are integrated inside the outer housing, such that the whole process from biological product sample processing to result testing can be completed in one device. Through the design of the moving mechanism 500, the instrument can automatically move the microplate and the pipettes 521, thereby reducing steps and time of manual operation, and enhancing testing efficiency; automatic operation also helps reduce human errors and enhance accuracy of test results; and besides, all components inside the instrument are distributed reasonably according to a testing sequence, such that a moving path of the moving mechanism 500 is more concise, and the problem of repeated movement of the moving mechanism 500 is solved.

Referring to FIG. 1 and FIG. 2, a collection box 800 is arranged between the pipette holder 600 and the shaking mechanism 100, and is configured to collect used pipettes 521. The collection box 800 for collecting the pipettes 521 is arranged between the pipette holder 600 and the shaking mechanism 100, and after the test reagents or test samples are added into the microplate on the shaking mechanism 100 through the pipettes 521, the used pipettes 521 are driven by the moving mechanism 500 to move to a position above the collection box 800, the moving mechanism 500 is separated from the pipettes 521, and the pipettes 521 drop into the collection box 800; and after separation from the pipette 521, the moving mechanism 500 moves to a position above the pipette holder 600 and is equipped with unused pipettes 521, thereby further optimizing the moving path of the moving mechanism 500 and enhancing the testing efficiency.

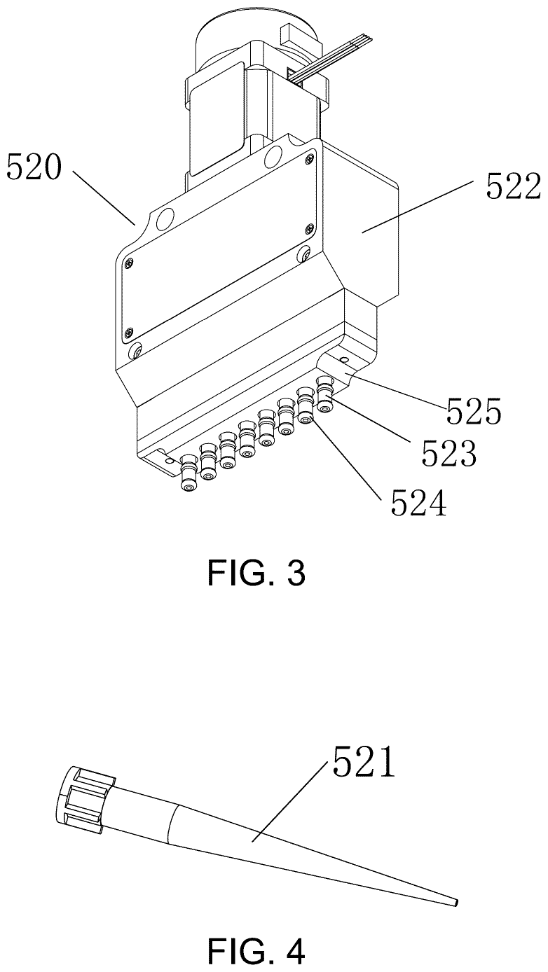

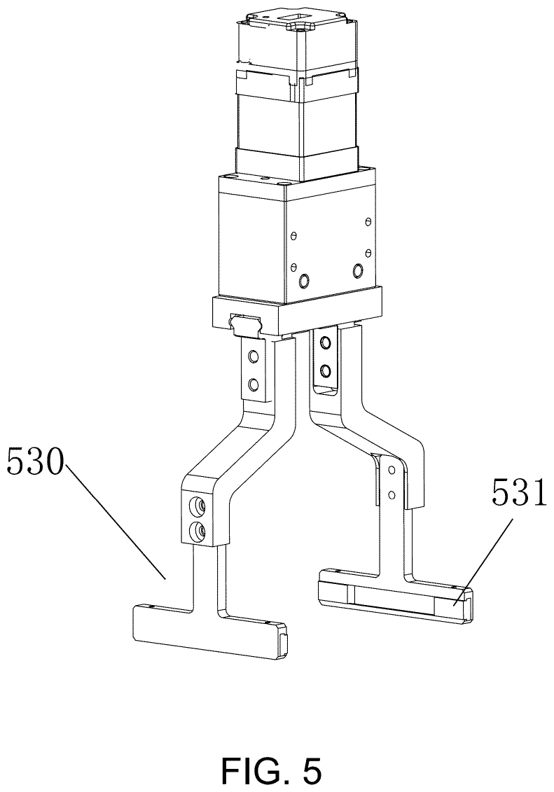

Referring to FIG. 3, FIG. 4, and FIG. 5, the moving mechanism 500 includes a mounting base 510, a pipetting assembly 520, a clamping assembly 530, a driving assembly, a first lifting component, and a second lifting component. The driving assembly is fixedly connected to the outer housing, and the mounting base 510 is fixedly connected with the driving assembly. In the embodiment, the driving assembly is two sets of conventional lead screw driving mechanisms, and the two sets of conventional lead screw driving mechanisms drive the mounting base 510 to move in a plane parallel to a bottom surface of the outer housing.

The pipetting assembly 520 is connected with the mounting base 510 through the first lifting component, the first lifting component drives the pipetting assembly 520 to move in a direction perpendicular to the bottom surface of the outer housing, and the pipetting assembly 520 is detachably connected with the pipettes 521. The clamping assembly 530 is connected with the mounting base 510 through the second lifting component, the second lifting component drives the clamping assembly 530 to move in a direction perpendicular to the bottom surface of the outer housing, and the clamping assembly 530 is configured to clamp the microplate.

Referring to FIG. 3 and FIG. 4, the pipetting assembly 520 includes the pipettes 521 and a pipetting gun 522. The pipetting gun 522 is fixedly connected with the first lifting component. The pipetting gun 522 includes a plurality of connecting nozzles 523 configured to be connected with the pipettes 521, the connecting nozzles 523 are hollow pipe structures, two sealing rings 524 are arranged on an outer wall of each connecting nozzle 523, the two sealing rings 524 are arranged in an axial direction of each connecting nozzle 523, and the connecting nozzles 523 are in interference fit with openings of the pipettes 521.

The two sealing rings 524 are arranged on the outer wall of each connecting nozzle 523, such that a sealing effect at connection portions of the connecting nozzles 523 and the pipettes 521 is enhanced, and connection between the connecting nozzles 523 and the pipettes 521 is more stable. Therefore, a liquid is transferred more stably in the pipetting process, and errors due to liquid leakage or connection loosening are reduced.

Referring to FIG. 3, a separating plate 525 is arranged on the pipetting gun 522, and is provided with a plurality of through holes, the plurality of through holes are in one-to-one correspondence with the plurality of connecting nozzles 523, and the connecting nozzles 523 are inserted into corresponding through holes. The separating plate 525 is connected with the pipetting gun 522 through an electric push cylinder, and the electric push cylinder drives the separating plate 525 to slide in the axial direction of each connecting nozzle 523.

When the pipettes 521 are used and required to be separated from the pipetting gun 522, the electric push cylinder drives the separating plate 525 to move close to the pipettes 521, and the separating plate 525 is abutted against end parts of the pipettes 521. The electric push cylinder continues to push the separating plate 525 to move, and the pipettes 521 are separated from the connecting nozzles 523 of the pipetting gun 522 under a pushing force of the separating plate 525, thereby enhancing convenience in simultaneously separating a plurality of pipettes 521 from the connecting nozzles 523 of the pipetting gun 522 and enhancing the testing efficiency.

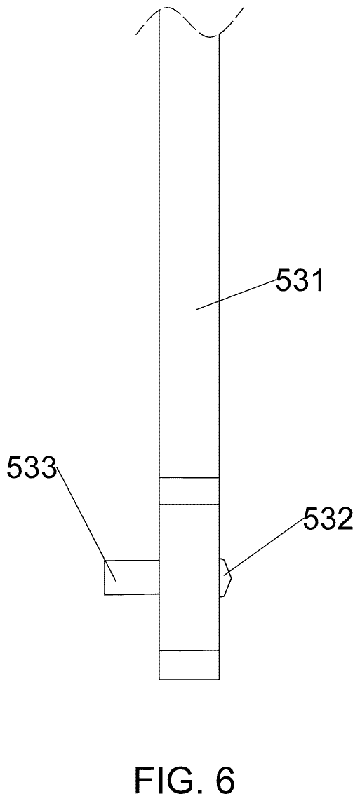

Referring to FIG. 5 and FIG. 6, the clamping assembly 530 includes a driving element and two clamping jaws 531. The driving element is connected with the second lifting component, and drives the two clamping jaws 531 to approach or separate from each other, two tapered lugs 532 are arranged on each of the sides, close to each other, of the two clamping jaws 531, and the two tapered lugs 532 are arranged symmetrically. In the embodiment, the driving element is a conventional lead screw driving structure.

When the microplate is clamped, four tapered lugs 532 are abutted against side walls of the microplate, and the design of the tapered lugs 532 increases a frictional force when the clamping jaws 531 are in contact with the microplate, such that the microplate is clamped more steadily. Additionally, symmetrical arrangement of the tapered lugs 532 ensures uniform distribution of a clamping force, and avoids damage of an object or unsteady clamping due to a nonuniform clamping force.

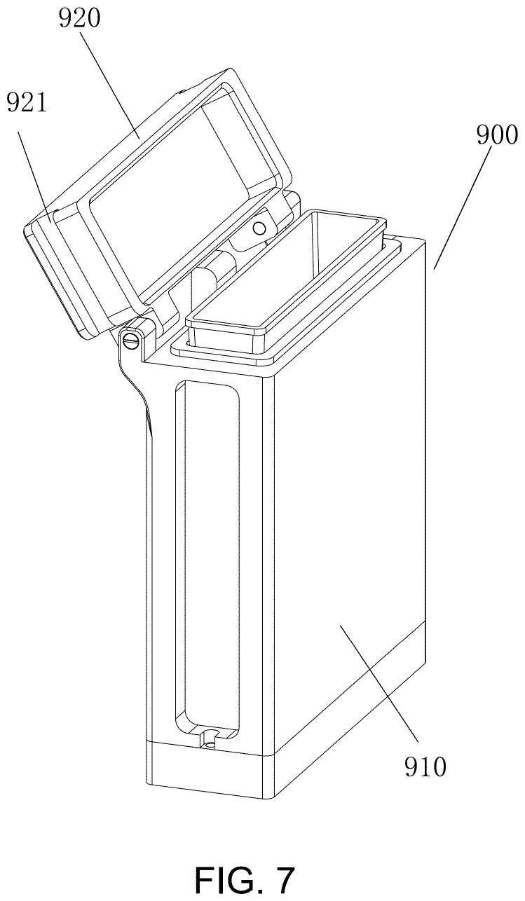

Referring to FIG. 7, the anti-volatilization reagent kit 900 includes a kit body 910 and a kit cover 920, the kit body 910 is configured to accommodate the volatile test reagents, the kit cover 920 is hinged with the kit body 910, the kit cover 920 is configured to seal an opening of the kit body 910, side walls of the kit cover 920 are provided with grooves 921, a length direction of each groove 921 is perpendicular to a rotary axis of the kit cover 920, and pulling blocks 533 configured to be inserted into the grooves 921 are arranged on side walls, far from the tapered lugs 532, of the clamping jaws 531.

The anti-volatilization reagent kit 900 is arranged inside the outer housing, and the anti-volatilization reagent kit 900 is configured to accommodate the volatile test reagents, to effectively seal the reagents and prevent the reagents from dispersing into the air, thereby ensuring purity and stability of the reagents and enhancing the testing accuracy. Moreover, the side walls of the kit cover 920 are provided with the grooves 921, the pulling blocks 533 matched with the grooves 921 are arranged on the clamping jaws 531, and when the kit cover 920 is required to be opened, the clamping jaws 531 may be inserted into the grooves 921 through the pulling blocks 533, and the driving assembly drives the clamping jaws 531 to move, so as to drive the kit cover 920 to rotate and open, thereby improving an automation level of the testing instrument and allowing the testing process to be more smooth and efficient.

Referring to FIG. 5, the pulling blocks 533 are cylinder structures, and one ends of the pulling blocks 533 are fixedly connected with the clamping jaws 531. The pipette holder 600 limits an opening angle of the kit cover 920 to less than 180 degrees. By arranging the pulling blocks 533 as the cylinder structures, the pulling blocks 533 are matched with the grooves 921 more smoothly, thereby enhancing precision and stability of opening the kit cover 920. When the test reagents in the anti-volatilization reagent kit 900 are completely used, the pulling blocks 533 on the clamping jaws 531 are utilized to push the kit cover 920 to rotate from one side, deviated from the kit body 910, of the kit cover 920, such that the kit cover 920 is fastened to the kit body 910.

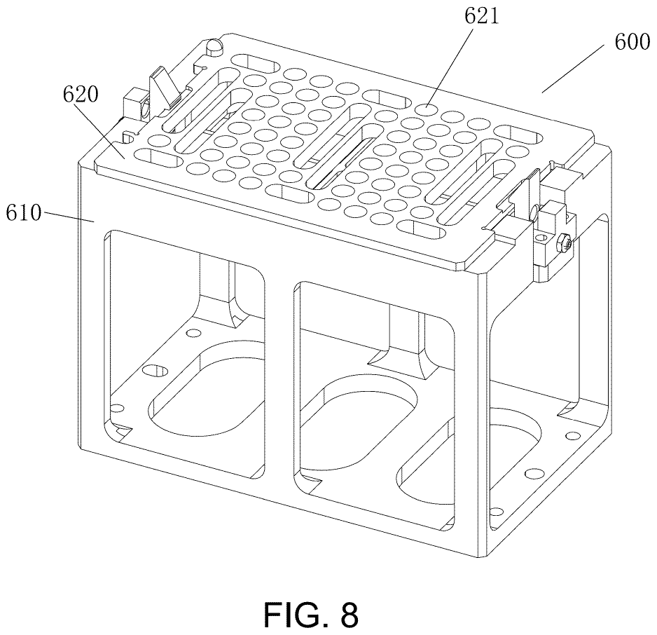

Referring to FIG. 8, the pipette holder 600 includes a holder body 610 and a pipette holding plate 620, a plurality of holding holes 621 for holding the pipettes 521 are formed in the pipette holding plate 620, the pipette holding plate 620 is detachably connected with the holder body 610, the anti-volatilization reagent kit 900 is located on one side of the pipette holder 600, and the pipette holder 600 limits the opening angle of the kit cover 920 to less than 180 degrees.

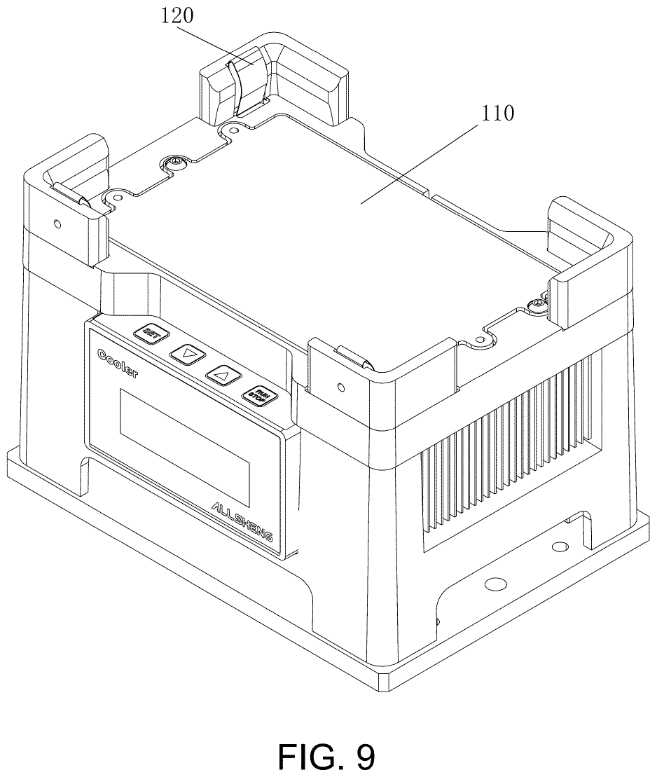

Referring to FIG. 9, the shaking mechanism 100 includes a supporting tray 110 configured to clamp the microplate, and any three inner walls of the supporting tray 110 are fixedly connected with spring discs 120. The supporting tray 110 is configured to clamp the microplate, and the microplate may be securely fixed to the shaking mechanism 100, thereby avoiding experimental errors due to looseness in the shaking process; the spring discs 120 have excellent elasticity and restoring ability, and can generate stable vibration waves in the shaking process, such that liquids or samples in the microplate can be uniformly mixed; and moreover, any three inner walls of the supporting tray 110 are fixedly connected with the spring discs 120, such that the microplate is located more precisely, and the stability of clamping the microplate by the clamping assembly 530 is enhanced.

The embodiment also discloses an automatic testing method for a fully automatic medicine testing instrument, which mainly includes the following steps.

At step 101, target positional information is configured for a pipettor, to ensure that the pipettor automatically moves according to the target positional information. In this way, the pipettor may obtain a specific target position to which it needs to move, and then may automatically move, to ensure to reach the accurate position. The pipettor may be a pipetting gun 522, and the target position may indicate a position of a pipette tip, a position of each different reagent, a position of a shaker, etc.

At step 102, real-time positional information of the pipettor is obtained. At step 103, when the pipettor is located at an operating point position, a liquid level detection instruction is sent to a liquid level detection sensor and current liquid level information is obtained. When the pipettor reaches a liquid aspiration position, it indicates that the pipettor is about to aspirate liquid. Liquid level detection is performed first, to obtain the current liquid level information.

At step 104, a vertical movement distance is calculated based on the current liquid level information when the current liquid level information is inconsistent with preset empty liquid level information. This prevents aspirating in the absence of liquid, avoids false indications of liquid acquisition, and enhances the testing accuracy.

At step 1041, a first parameter of a corresponding container is obtained by looking up a table based on a current operating point position. Different operating points correspond to different containers for containing solutions, and thus they have different heights. This facilitates determination of heights of the pipettor and the liquid level and subsequent determination of a final position of the movement.

At step 1042, during liquid aspiration, based on a current liquid aspiration volume, the current liquid level information is corrected when the current liquid aspiration volume is greater than a first threshold. Since the liquid aspiration volume each time is approximately 5 mL, if the liquid aspiration volume is large, a liquid level change is great, and the liquid level detection sensor has a certain error. The pipettor aspirates the liquid through the tip of the pipetting gun 522. The pipettor is connected with the tip of the pipetting gun 522, a height of the tip of the pipetting gun 522 is approximately 5 cm, and when the liquid is aspirated or dispensed, the tip of the pipetting gun 522 needs to extend below the liquid level, such that the tip of the pipetting gun 522 is in contact with a part of the liquid, which may influence the testing accuracy. Therefore, a bottom of the tip of the pipetting gun 522 is controlled to extend below the liquid level by 3-4 mm. In the liquid aspiration process, the liquid level may fluctuate downward. Therefore, to accurately control the tip of the pipetting gun 522 to extend below the liquid level, parameters are required to be set according to changes of the liquid aspiration volume and the current liquid aspiration volume, to correct the current liquid level information.

At step 1043, the vertical movement distance is calculated based on the first parameter and the corrected liquid level information, and the movement distance is sent to the pipettor, to control an immersion depth of the pipettor below the liquid level. In this way, the immersion depth of the pipettor may be accurately controlled. By knowing a height from the tip of the pipetting gun 522 to a top of the container and combining a height of the liquid level, a downward movement distance of the pipetting gun 522 may be calculated.

Therefore, processes such as liquid aspiration, liquid preparation, and testing are implemented in sequence according to the position reached by the pipettor, to accurately complete the testing process, and precisely complete the automatic testing process under the condition of needing different reagents and repeated tests in the testing process.

In some embodiments, based on the current liquid aspiration volume, when the current liquid aspiration volume is greater than the first threshold, the current liquid level information is corrected, including: the corrected liquid level information is obtained according to an equation (1):

$$H = h - ( ( L \times σ ) / 5 ) \qquad ( 1 )$$

where L denotes the current liquid aspiration volume, h denotes a currently detected liquid level height, and σ denotes a coefficient ranging from 0.8 to 1.

The first threshold may be 3 mL, etc. A value of σ may be selected according to types of solutions, and is large for high viscosity solutions; and it is also determined by the current liquid aspiration volume, and if the current liquid aspiration volume is large, the value of σ is large. For example, if the liquid level is detected at 10 cm, 3 mL of liquid is aspirated last time, and σ is 0.8, so H=9.62 cm. In this way, a descending height of the tip of the pipetting gun 522 may be controlled, the accuracy of the liquid level height is enhanced, the immersion depth of the tip of the pipetting gun 522 is not changed largely, the liquid may be aspirated, and the liquid aspiration volume less than a preset volume due to fluctuation of the liquid level is prevented.

In some embodiments, target positional information is configured for a pipettor, to ensure that the pipettor automatically moves according to the target positional information, including: positional information of each target point is obtained; by taking the pipettor as a center point of a three-dimensional coordinate system, target coordinate point information of each target point in the three-dimensional coordinate system is obtained based on the positional information of each target point; and target coordinate point information of a liquid preparation point and each liquid aspiration point is sent to the pipettor, to ensure that the pipettor moves according to the target coordinate point information.

The positional information of each target point may be manually input information and pre-stored. Then, an initial position of the pipettor is taken as the center point of the three-dimensional coordinate system, and a relative distance from each target point to the initial position of the pipettor is obtained, such that the target coordinate point information, namely, X-direction information, Y-direction information, and Z-direction information, of each target point in the three-dimensional coordinate system may be obtained, and the pipettor moves conveniently. In some embodiments, the automatic testing method further includes: X-axis coordinate information, Y-axis coordinate information, and Z-axis coordinate information of the target point are obtained based on the target coordinate point information; and the pipettor moves in sequence according to the X-axis coordinate information, the Y-axis coordinate information, and the Z-axis coordinate information. For example, a target coordinate is (10000, 3000, 2000), the pipettor moves to 10000 in a X axis first, then moves to 3000 in a Y axis, and then moves to 2000 in a Z axis. Because of wide variety of the reagents and different locations of liquid preparation points, the precise target positional information facilitates precise completion of the testing process by the pipettor. A middle position between a top of the pipettor and a top of a container containing a solution may be selected as a final position of the pipettor after movement.

In some embodiments, the automatic testing method further includes: real-time positional information of the pipettor is obtained and converted into real-time coordinate information in a three-dimensional coordinate system, and alarm information is sent when the real-time coordinate information is not within a range of the target coordinate point information. Positional information of the pipettor may be obtained through a position sensor. For example, the position sensor is arranged on the pipettor. The real-time positional information of the pipettor may be obtained at a first interval, such as 5 s. If the real-time coordinate information is within the range of the target coordinate point information, it indicates that the pipettor is in the normal pipetting process, an alarm is not required, and the pipettor continues to move. If the real-time coordinate information is not within the range of the target coordinate point information, it indicates that the pipettor deviates from a normal path, and the alarm information is sent.

In some embodiments, when the real-time coordinate information is within the range of the target coordinate point information, alarm information is sent, including:
coordinate values of X, Y, and Z axes in the real-time coordinate information are compared with coordinate values of X, Y, and Z axes in the target coordinate point information, and when the coordinate values of the X, Y, and Z axes in the real-time coordinate information are greater than those in the target coordinate point information, the alarm information is sent. For example, a target coordinate is (10000, 3000, 2000), the real-time positional information is (10000, 2000, 0), and this indicates that the real-time coordinate information is within the range of the target coordinate point information.

In some embodiments, after moving to a target point, the pipettor returns to an initial position, and then moves to the next target point. Therefore, this prevents moving to a wrong position if the pipettor directly moves from one target point to the next target point due to problems such as identification of coordinate information.

In some embodiments, when the current liquid level information is inconsistent with preset empty liquid level information, a liquid aspiration instruction is sent to the pipettor, including: the current liquid level information and the empty liquid level information are respectively a current voltage value and an empty liquid level voltage value, and when the current voltage value is inconsistent with the empty liquid level voltage value, the liquid aspiration instruction is sent to the pipettor. A voltage converter is arranged inside the liquid level detection sensor, and after the liquid level detection sensor detects a liquid level, the voltage converter outputs a corresponding voltage value, to facilitate automatic determination of the liquid level.

In some embodiments, the automatic testing method further includes: liquid adding prompting information is sent when the current liquid level information is inconsistent with the preset empty liquid level information. In the absence of liquid, liquid aspiration is not performed, and a prompt is sent, to allow a worker to timely add liquid.

Operating points include liquid aspiration points, liquid preparation points, and/or detection points.

When the pipettor is positioned at a liquid preparation point, a liquid preparation instruction is sent to a liquid preparation device, and after completion of liquid preparation, a liquid aspiration instruction is sent to the pipettor. The liquid preparation device may include a shaker or a heater, and when the pipettor is positioned at the liquid preparation point, the shaker shakes the liquid according to the liquid preparation instruction, to fully mix the liquid, or the heater heats the liquid according to the liquid preparation instruction. When the pipettor is positioned at a detection point, a detection instruction is sent to a detection device, such that the detection device starts detection and obtains a detection result. The detection device may be an optical analysis system to obtain optical analysis results.

The embodiment of the present disclosure also provides an automatic testing system for a fully automatic medicine testing instrument. The automatic testing system includes a pipettor, a control module, and a liquid level detection sensor. The control module is configured to configure target positional information for the pipettor, to ensure that the pipettor automatically moves according to the target positional information, obtain real-time positional information of the pipettor, send a liquid level detection instruction to the liquid level detection sensor and obtain current liquid level information when the pipettor is located at an operating point position, and calculate a vertical movement distance based on the current liquid level information when the current liquid level information is inconsistent with preset empty liquid level information, including: obtain a first parameter of a corresponding container by looking up a table based on a current operating point position, correct the current liquid level information when the current liquid aspiration volume is greater than a first threshold during liquid aspiration, calculate the vertical movement distance based on the first parameter and the corrected liquid level information, and send the movement distance to the pipettor, to control an immersion depth of the pipettor below a liquid level.

Different reagents, pipette tips, and containers (e.g. the reagent reservoir 300 and the anti-volatilization reagent kit 900) are placed at different positions, the pipettor is located above, and through implementation steps of the control module, the automatic testing process can be better completed precisely based on the fully automatic medicine testing instrument. The control module is in communication connection with the pipettor and the liquid level detection sensor, to transmit signals.

In some embodiments, the automatic testing system further includes a display module. The display module may display testing results, and may also display testing progress, etc. The display module may also be provided with a touch screen, to facilitate corresponding operations of operators. Information related to the control module may be output to the display module, to be displayed.

In some embodiments, the automatic testing system further includes a position sensor. For example, the position sensor is arranged on the pipettor, and positional information of the pipettor is obtained by the position sensor.

In some embodiments, target positional information is configured for a pipettor, to ensure that the pipettor automatically moves according to the target positional information, including: positional information of each target point is obtained; by taking the pipettor as a center point of a three-dimensional coordinate system, target coordinate point information of each target point in the three-dimensional coordinate system is obtained based on the positional information of each target point; and the target coordinate point information of each target point is sent to the pipettor, to ensure that the pipettor moves according to the target coordinate point information.

In some embodiments, the control module is also configured to obtain real-time positional information of the pipettor, convert it into real-time coordinate information in a three-dimensional coordinate system, and send alarm information when the real-time coordinate information is not within a range of the target coordinate point information.

The embodiment of the present disclosure also provides a non-transitory computer-readable medium on which instructions are stored. A processor executes the instructions such as steps of the automatic testing method for the fully automatic medicine testing instrument in any embodiment of the present disclosure.

Each embodiment in the disclosure is described in a progressive mode, same or similar parts of the embodiments may be mutually referenced, and a mainly explained part in each embodiment is a difference from other embodiments.

The above descriptions are all preferred embodiments of the present disclosure, but are not in turn to limit the protection scope of the present disclosure. Therefore, any equivalent changes made based on the structure, shape, and principle of the present disclosure shall fall within the protection scope of protection of the present disclosure. In the present disclosure, any unspecified aspects can be implemented by adopting or referencing the prior art.

What is claimed is:

1. A fully automatic medicine testing instrument, comprising an outer housing,
wherein a shaking mechanism (100), a heating mechanism (200), a reagent reservoir (300), an optical detection mechanism (400), a moving mechanism (500), a pipette holder (600), and a microplate holder (700) are arranged inside the outer housing,
the reagent reservoir (300) is configured to store test samples and test reagents,
the pipette holder (600) is configured to hold pipettes (521) for transferring reagents,
the pipettes (521) are configured to draw the test samples and the test reagents,
the microplate holder (700) is configured to hold a microplate for treating the test samples,
the moving mechanism (500) is configured to move the microplate and the pipettes (521),
the shaking mechanism (100) is configured to shake the microplate,
the heating mechanism (200) is configured to heat the reagents in the microplate,
the optical detection mechanism (400) is configured to test absorbance of the test samples,
the moving mechanism (500) is connected to an inner top of the outer housing,
the reagent reservoir (300) is located in a middle of a bottom of the outer housing,
the pipette holder (600) and the microplate holder (700) are respectively located on two sides of the reagent reservoir (300),
the optical detection mechanism (400) and the shaking mechanism (100) are respectively located on the other two sides of the reagent reservoir (300), and
the heating mechanism (200) is located on one side, close to the microplate holder (700), of the shaking mechanism (100);
wherein the moving mechanism (500) comprises a mounting base (510), a pipetting assembly (520), a clamping assembly (530), a driving assembly, a first lifting component, and a second lifting component,
the driving assembly is connected with the outer housing,
the mounting base (510) is connected with the driving assembly,
the driving assembly drives the mounting base (510) to move in a plane parallel to the bottom of the outer housing,
the pipetting assembly (520) is connected with the mounting base (510) through the first lifting component,
the first lifting component drives the pipetting assembly (520) to move in a direction perpendicular to the bottom of the outer housing,
the pipetting assembly (520) is detachably connected with the pipettes (521),
the clamping assembly (530) is connected with the mounting base (510) through the second lifting component,
the second lifting component drives the clamping assembly (530) to move in the direction perpendicular to the bottom of the outer housing, and
the clamping assembly (530) is configured to clamp the microplate; and
wherein the pipetting assembly (520) comprises the pipettes (521) and a pipetting gun (522),
the pipetting gun (522) comprises a plurality of connecting nozzles (523) configured to be connected with the pipettes (521),
the plurality of connecting nozzles (523) are hollow pipe structures,
two sealing rings (524) are arranged on an outer wall of each of the plurality of connecting nozzles (523),
the two sealing rings (524) are arranged in an axial direction of each of the plurality of connecting nozzles (523), and
the plurality of connecting nozzles (523) are in interference fit with openings of the pipettes (521).

2. The fully automatic medicine testing instrument according to claim 1, wherein a collection box (800) is arranged between the pipette holder (600) and the shaking mechanism (100), and is configured to collect used pipettes (521).

3. The fully automatic medicine testing instrument according to claim 1, wherein a separating plate (525) is arranged on the pipetting gun (522), and is provided with a plurality of through holes;
the plurality of through holes are in one-to-one correspondence with the plurality of connecting nozzles (523);
the plurality of connecting nozzles (523) are inserted into corresponding through holes;
the separating plate (525) is connected with the pipetting gun (522) through an electric push cylinder; and
the electric push cylinder drives the separating plate (525) to slide in the axial direction of each of the plurality of connecting nozzle (523).

4. The fully automatic medicine testing instrument according to claim 3, wherein the clamping assembly (530) comprises a driving element and two clamping jaws (531);
the driving element is connected with the second lifting component, and drives the two clamping jaws (531) to approach or separate from each other;
two tapered lugs (532) are arranged on each of sides, close to each other, of the two clamping jaws (531); and
the two tapered lugs (532) are arranged symmetrically.

5. The fully automatic medicine testing instrument according to claim 4, wherein an anti-volatilization reagent kit (900) is arranged inside the outer housing, is configured to accommodate volatile test reagents, and comprises a kit body (910) and a kit cover (920);
the kit body (910) is configured to accommodate the volatile test reagents;
the kit cover (920) is hinged with the kit body (910), and is configured to seal an opening of the kit body (910);
side walls of the kit cover (920) are provided with grooves (921);
a length direction of each of the grooves (921) is perpendicular to a rotary axis of the kit cover (920); and
pulling blocks (533) configured to be inserted into the grooves (921) are arranged on side walls, far from the tapered lugs (532), of the clamping jaws (531).

6. The fully automatic medicine testing instrument according to claim 5, wherein the pipette holder (600) comprises a holder body (610) and a pipette holding plate (620);
a plurality of holding holes (621) for holding the pipettes (521) are formed in the pipette holding plate (620);
the pipette holding plate (620) is detachably connected with the holder body (610);
the anti-volatilization reagent kit (900) is located on one side of the pipette holder (600); and
the pipette holder (600) limits an opening angle of the kit cover (920) to less than 180 degrees.

7. The fully automatic medicine testing instrument according to claim 1, wherein the shaking mechanism (100) comprises a supporting tray (110) configured to clamp the microplate, and any three inner walls of the supporting tray (110) are fixedly connected with spring discs (120).

8. An automatic testing method for a fully automatic medicine testing instrument, wherein the automatic testing method is applied to the fully automatic medicine testing instrument according to claim 1, and comprises:
configuring target positional information for a pipettor, the pipettor being a pipetting gun, to ensure that the pipettor automatically moves according to the target positional information;
obtaining real-time positional information of the pipettor;
sending a liquid level detection instruction to a liquid level detection sensor and obtaining current liquid level information when the pipettor is located at an operating point position; and
calculating a vertical movement distance based on the current liquid level information when the current liquid level information is inconsistent with preset empty liquid level information, comprising:
obtaining a first parameter of a corresponding container by looking up a table based on a current operating point position;
during liquid aspiration, based on a current liquid aspiration volume, correcting the current liquid level information when the current liquid aspiration volume is greater than a first threshold; and
calculating the vertical movement distance based on the first parameter and the corrected liquid level information, and sending the vertical movement distance to the pipettor, to control an immersion depth of the pipettor below a liquid level.
